(19) United States
(12) Patent Application Publication
(10) Pub. No.: US 2012/0312641 A1
(43) Pub. Date: Dec. 13, 2012

(54) Bicycle brake device

(76) Inventor: Jr-Yuan JANG, Changhwa City (TW)

(21) Appl. No.: 13/470,298

(22) Filed: May 12, 2012

(30) Foreign Application Priority Data
Jun. 10, 2011 (TW) 100210535

(51) Int. Cl. B62L 1/16

(52) U.S. Cl. 188/24.22

(57) ABSTRACT

A bicycle brake device is provided with a torsion spring on each of two brake arms, and the torsion spring has one end fixed to the fork tube of the bicycle and another end abutted against the brake arms to restrict a pivoting angle of the brake arm. The bicycle brake device is easy to assembly and capable of adjusting the position of the brake shoes as desired. In the case that the steel cord is broken, the bicycle brake device is further capable of preventing the brake arms from pivoting too far and getting stuck in the wheel, so as to improve riding safety.

### BACKGROUND OF THE INVENTION

1. Field of the Invention

The present invention relates to a safety brake device, and more particularly to a bicycle brake device.

2. Description of the Prior Art

FIGS. 1 and 2 show a conventional bicycle brake 10 which comprises two brake arms 11, each of the brake arms 11 consists of two opposite plates 111 fixed together by a fastener 112 and is provided with a torsion spring 12 with respect to the fork tubes X. Each of the fork tubes X is provided with a positioning portion X1 and a protruding rod X2. The torsion spring 12 has a positioning end 121 inserted in one of the positioning holes (not numbered) formed in the positioning portion X1, a restricting end 122 inserted in the brake arms 11, and a deformable body 123 between the positioning and restricting ends 121, 122 sleeved on the protruding rod X2. A brake shoe 13 is inserted in each of the fasteners 112 and fixed to the brake arms 11, and then the two brake arms 11 are connected by a steel cord 14.

The positioning and restricting ends 121, 122 are only capable of preventing rotation of the torsion spring 12 without being able to stop the torsion spring 12 from moving axially with respect to the protruding rod X2. It therefore has to use a fastener which is to be fixed on the protruding rod X2 to fix the torsion spring 12.

Furthermore, the torsion springs 12 can be assembled only when the brake arms 11 are mounted on the fork tubes X, which makes the assembly of such brake device more difficult. On top of that, the fixing position where the brake shoe 13 is fixed to the fastener 112 is fixed and cannot be adjusted as desired.

The present invention has arisen to mitigate and/or obviate the afore-described disadvantages.

### SUMMARY OF THE INVENTION

The primary object of the present invention is to provide a safety bicycle brake device which is easy to assembly and capable of adjusting the position of the brake shoes as desired. In the case that the steel cord is broken, the bicycle brake device is further capable of preventing the brake arms from pivoting too far and getting stuck in the wheel, so as to improve riding safety.

To achieve the above object, the bicycle brake device in accordance with the present invention comprises: two brake arms connected by a steel cord, and each of the brake arms including a first section, a second section and a third section. The first section has two ends connected to the second and third sections respectively, one end of the first section extends outward to form an assembling portion, the second section is connected to the third section, at a juncture of the second and third sections is pivotally disposed a fixing member for fixing the steel cord, on an outer surface of the second section is formed an abutting portion, an abutting cavity formed in the abutting portion. On the assembling portion of the first section is fixed a brake shoe. A torsion spring is pivotally disposed at a juncture of the first and second sections and includes a fixing end, a deformable body, an extension portion and a restricting end, the fixing end is fixed in a fork tube, the deformable body is a helical structure, the extension portion extends over the abutting portion of the second section and is abutted against the abutting cavity of the abutting portion, and the restricting end is abutted against the brake arm.

In normal conditions, the brake arms are pulled by the steel cord, and when the steel cord is broken, since each of the torsion springs has the restricting end inserted between the second and third sections of the respective brake arms to prevent the brake arms from freely swinging downward by gravity to get stuck in the wheel, thus improving riding safety.

Preferably, an elongated hole is formed in the assembling portion, and the brake shoe is fixed in the elongated hole of the assembling portion by a fastener.

Preferably, the restricting end of the torsion spring is L-shaped and inserted between the second and third sections of the brake arm to restrict a pivoting angle of the brake arm.

Preferably, the restricting end of the torsion spring is located adjacent to a corner between the second and third sections.

Preferably, the restricting end of the torsion spring is a semicircular structure to hook a far side of the fixing member with respect to the brake shoes.

Preferably, a threaded hole is formed in the abutting cavity, and an adjustment bolt is screwed in the threaded hole to push the extension portion of the torsion spring.

Preferably, an assembling hole is formed at a juncture of the second and first sections, the torsion spring is pivotally fixed to the brake arm by a positioning assembly which comprises a rod and a sleeve, the rod has one end formed with an inserting portion and another end formed with an engaging flange, the inserting portion is inserted in the assembling hole of the brake arm, the engaging flange is exposed out of the assembling hole, the sleeve is made of rubber and formed with a cylindrical body and a restricting flange, the deformable body of the torsion spring is sleeved on the cylindrical body of the sleeve, the cylindrical body is sleeved on the inserting portion of the rod and restricted from movement by the engaging flange, and consequently, the restricting flange of the sleeve is capable of restricting movement of the torsion spring. By such arrangements, the torsion spring can be assembled to the brake arm before assembling the fork tube (not shown), which makes the assembly of the present invention easier.

### BRIEF DESCRIPTION OF THE DRAWINGS

FIG. 1 is an illustrative view of a conventional bicycle brake device;

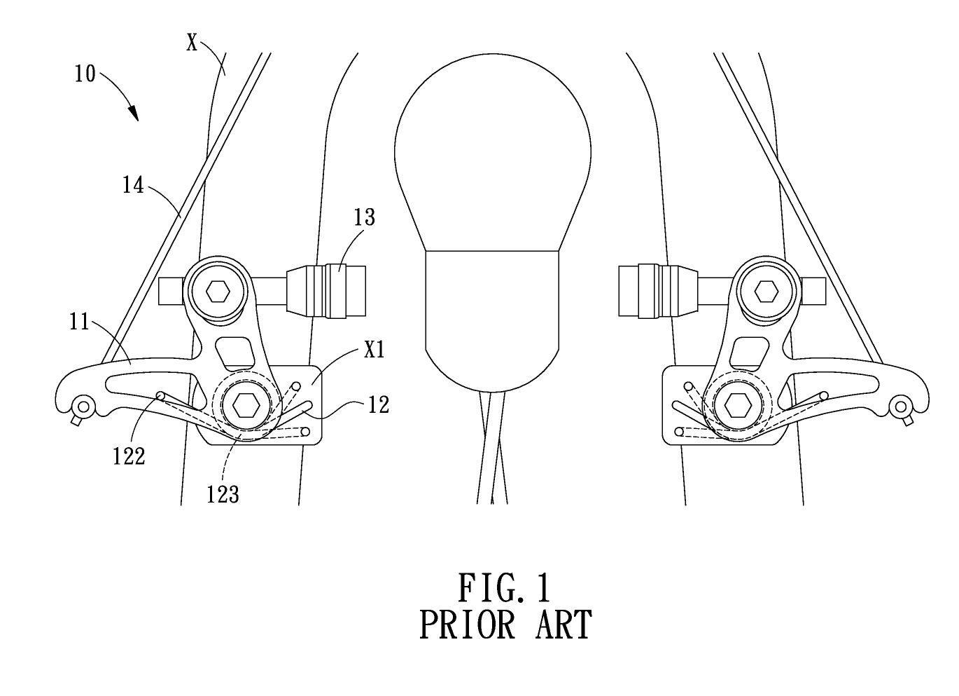

FIG. 2 is an exploded view of a part of the conventional bicycle brake device;

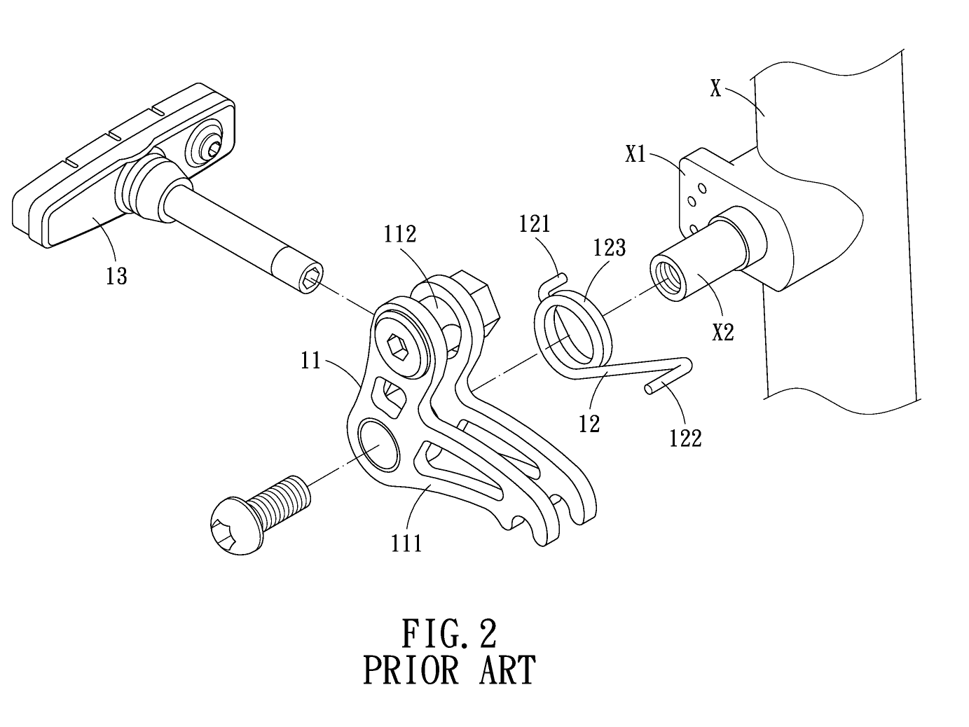

FIG. 3 is an exploded view of a part of a bicycle brake device in accordance with a preferred embodiment of the present invention;

FIG. 4 is a perspective view of a part of the bicycle brake device in accordance with the preferred embodiment of the present invention;

FIG. 5 is a side view of a part of the bicycle brake device in accordance with the preferred embodiment of the present invention;

FIG. 6 is an assembly view of the bicycle brake device in accordance with the preferred embodiment of the present invention;

FIG. 7 shows that the condition of the bicycle brake device in accordance with the present invention, when the steel cord is broken;

FIG. 8 is a magnified view of a part of FIG. 7; and

FIG. 9 shows another embodiment of the torsion spring of the bicycle brake device in accordance with the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

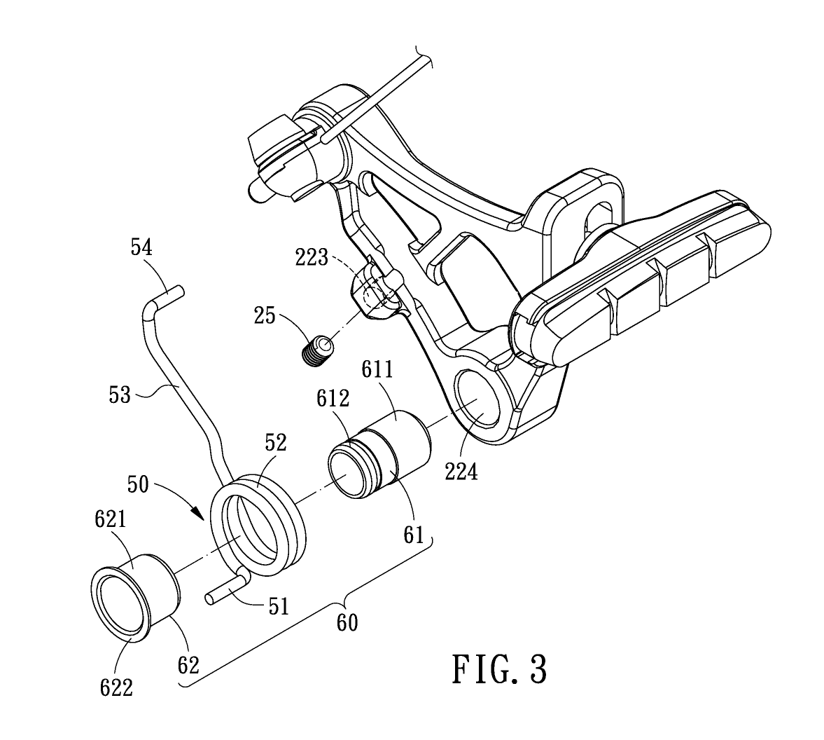

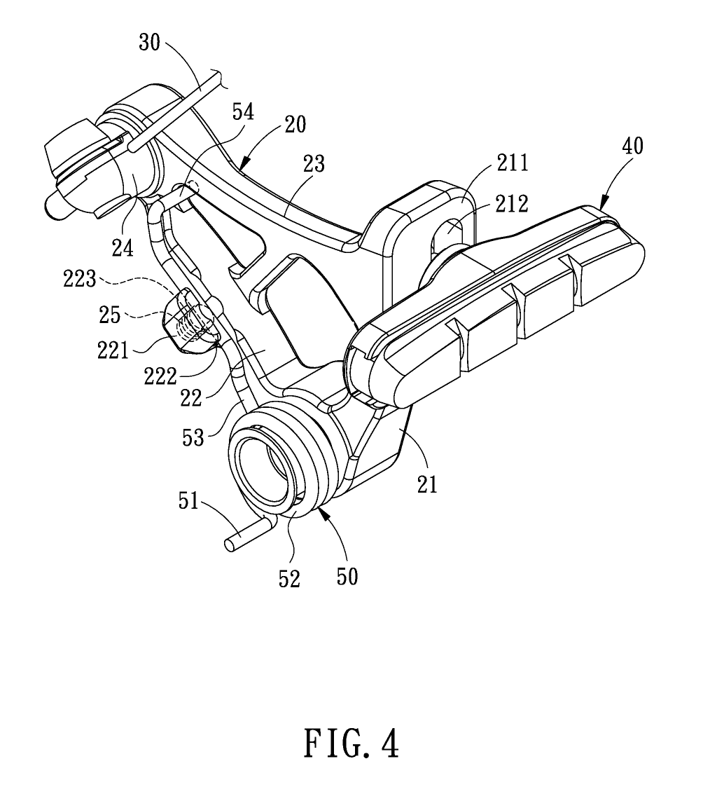

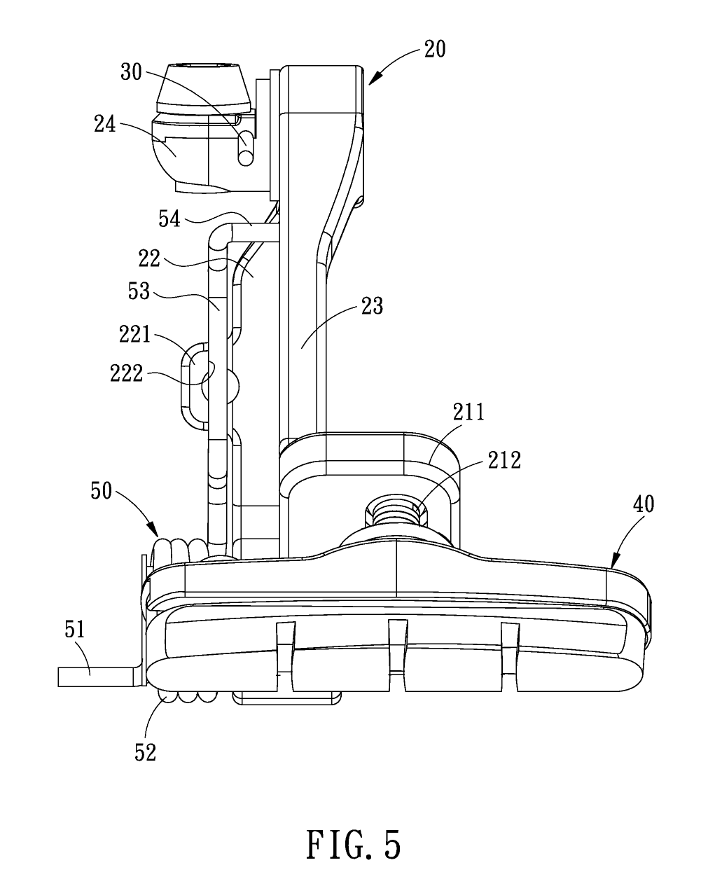

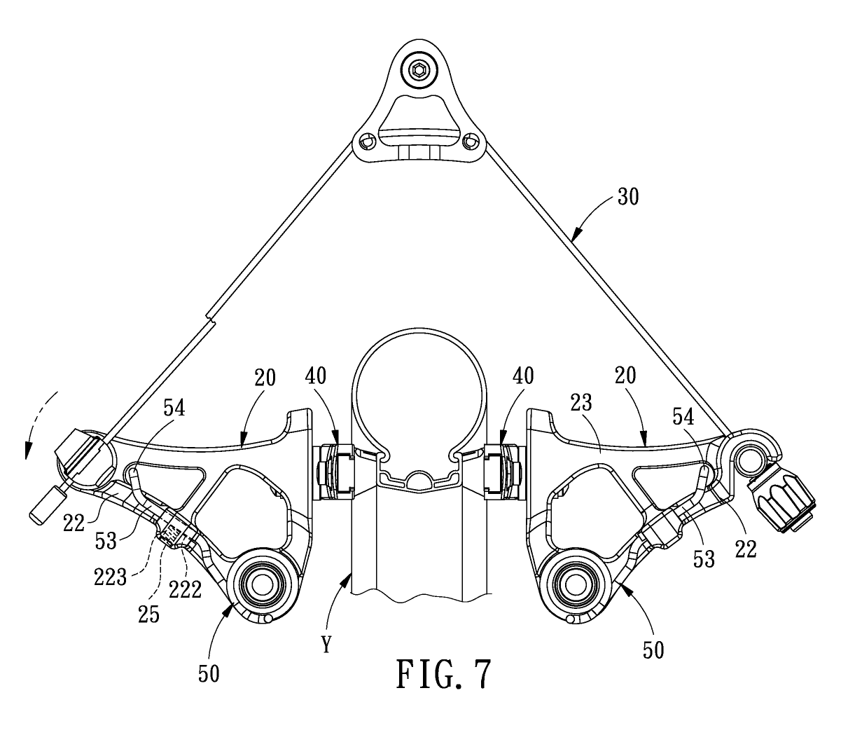

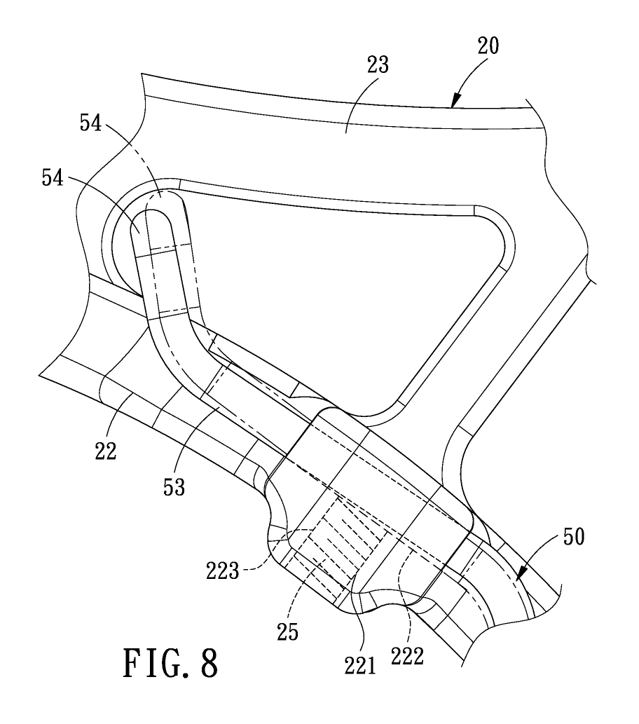

Referring to FIGS. 3-8, a bicycle brake device in accordance with a preferred embodiment of the present invention comprises two brake arms 20 connected by a steel cord 30, and each of the brake arms 20 includes a first section 21, a second section 22 and a third section 23.

The first section 21 has two ends connected to the second and third sections 22, 23 respectively, one end of the first section 21 extends outward to form an assembling portion 211, and in the assembling portion 211 is formed an elongated hole 212. The second section 22 is connected to the third section 23, at the juncture of the second and third sections 22, 23 is pivotally disposed a fixing member 24 for connecting and fixing the steel cord 30. On an outer surface of the second section 22 is formed an abutting portion 221, an abutting cavity 222 formed in the abutting portion 221, and a threaded hole 223 formed in the abutting cavity 222. An adjustment bolt 25 is screwed in the threaded hole 223. At the juncture of the second and first sections 22, 21 is formed an assembling hole 224.

On the assembling portion 211 of the first section 21 is fixed a brake shoe 40, and in this embodiment, the brake shoe 40 is fixed in the elongated hole 212 of the assembling portion 211 by a fastener.

A torsion spring 50 is pivotally disposed at the juncture of the first and second sections 21, 22 and includes a fixing end 51, a deformable body 52, an extension portion 53 and a restricting end 54. The fixing end 51 is fixed in the fork tube (not shown) of a bicycle, the deformable body 52 is a helical structure, the extension portion 53 extends over the abutting portion 221 of the second section 22 and is abutted against the abutting cavity 222 of the abutting portion 221 and is meanwhile pushed against by the adjustment bolt 25 which is screwed in the threaded hole 223. The restricting end 54 in this embodiment is L-shaped and inserted between the second and third sections 22, 23 of the brake arm 20 to restrict the pivoting angle of the brake arm 20. The pivot angle of the brake arm 20 with respect to the torsion spring 50 is restricted by the distance between the second and third sections 22, 23. In this embodiment, the restricting end 54 of the torsion spring 50 is located adjacent to a corner between the second and third sections 22, 23. In this embodiment, the torsion spring 50 is pivotally fixed to the brake arm 20 by a positioning assembly 60 which comprises a rod 61 and a sleeve 62. The rod 61 has one end formed with an inserting portion 611 and another end formed with an engaging flange 612. The inserting portion 611 is inserted in the assembling hole 224 of the brake arm 20, and the engaging flange 612 is exposed out of the assembling hole 224. The sleeve 62 is made of rubber formed with a cylindrical body 621 and a restricting flange 622. The deformable body 52 of the torsion spring 50 is sleeved on the cylindrical body 621 of the sleeve 62, and then the cylindrical body 621 is sleeved on the inserting portion 611 of the rod 61 and restricted from movement by the engaging flange 612. Consequently, the restricting flange 622 of the sleeve 62 is capable of restricting movement of the torsion spring 50. By such arrangements, the torsion spring 50 can be assembled to the brake arm 20 before assembling the fork tube (not shown), which makes the assembly of the present invention easier.

The brake shoes 40 of the two brake arms 20 are located at two opposite sides of the wheel Y of a bicycle. When the steel cord 30 is pressed to make the two brake arms 20 move toward the wheel Y, since the extension portion 53 of the torsion spring 50 is abutted against the abutting cavity 222, the brake arms 20 will push the torsion spring 50 and make the brake shoes 40 perform brake action by clamping the wheel Y. When the steel cord 30 is released, the torsion spring 50 will push the brake arms 20 back to their original positions, and consequently, the brake shoes 40 also move away from the wheel Y to cancel the brake action.

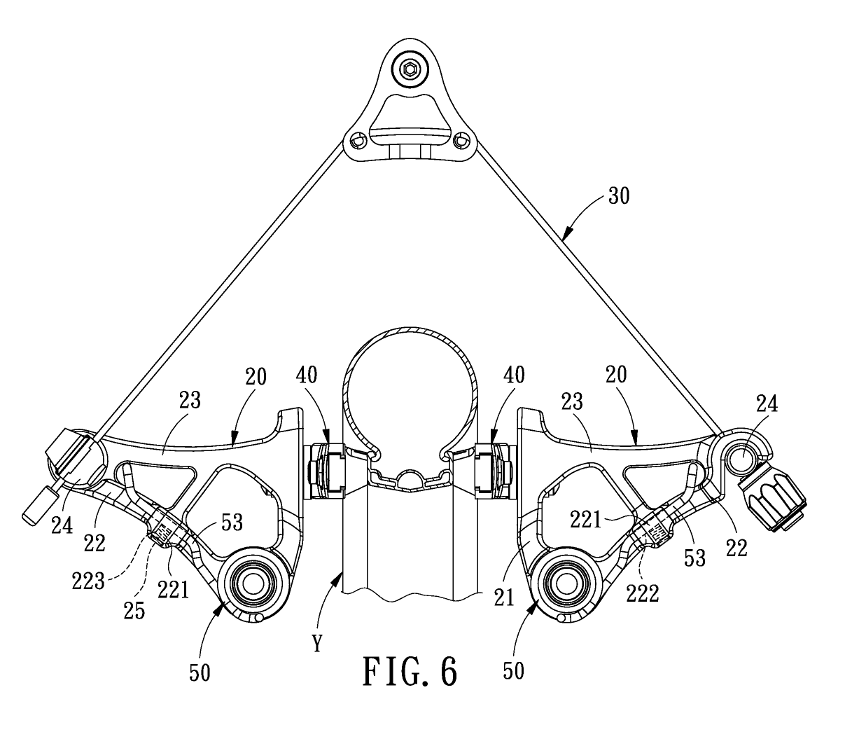

When the steel cord 30 is broken by wear and tear after long time of use, as shown in FIGS. 6-8, the pulling force of the steel cord 30 applied to the brake arms 20 suddenly disappears, consequently, the brake arms 20 will pivotally swing down by gravity. Each of the torsion springs 50 has the restricting end 54 inserted between the second and third sections 22, 23 of the respective brake arms 20 and another end fixed to the fork tubes (not shown), the limited distance between the second and third sections 22, 23 of the brake arms 20 cooperates with the restricting end 54 of the torsion springs 50 (the small distance between the second and third sections 22, 23 causes interference with the torsion spring 50) to restrict the pivoting angle (the angle that the brake arms are capable of pivotally swinging) of the brake arms 20, preventing the possibility that the brake arms 20 might pivot too far and get stuck in the wheel Y, which improves riding safety. Moreover, the pivoting angle of the brake arms 20 can be reduced to the minimum level by adjusting the adjustment bolt 25 to make the extension portion 53 of the torsion springs 50 lean against the third section 23.

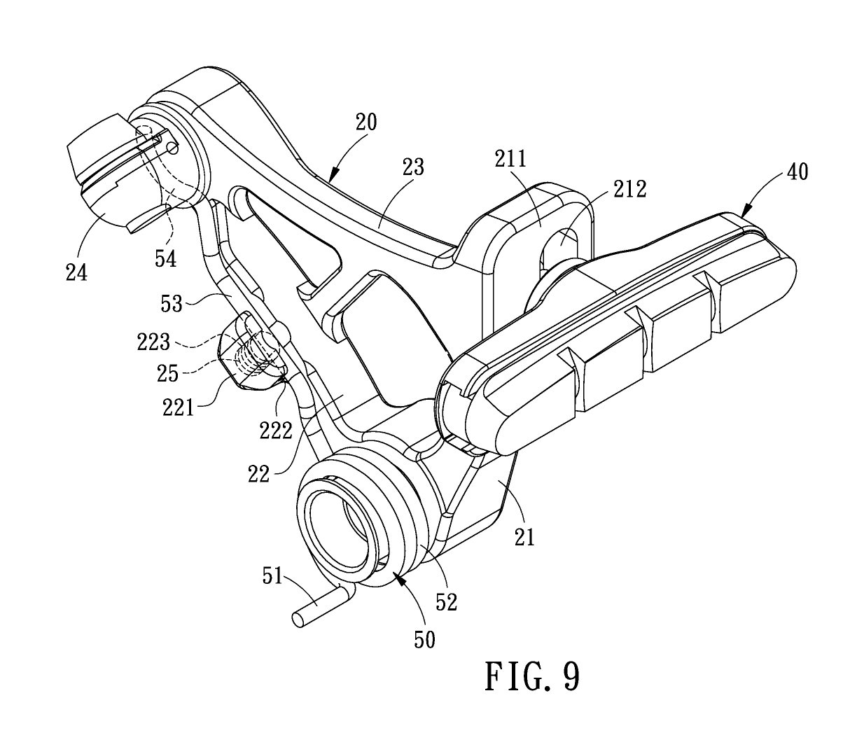

Referring to FIG. 9, another embodiment of the torsion spring 50 is shown, wherein the restricting end 54 of the torsion spring 50 is a semicircular structure to hook the far side of the fixing member 24 with respect to the brake shoes 40, so that the pivoting angle of the brake arms 20 can also be restricted by the torsion spring 50.

While we have shown and described various embodiments in accordance with the present invention, it is clear to those skilled in the art that further embodiments may be made without departing from the scope of the present invention.

What is claimed is:

1. A bicycle brake device comprising:
two brake arms connected by a steel cord, and each of the brake arms including a first section, a second section and a third section; wherein:
the first section has two ends connected to the second and third sections, respectively, one end of the first section extends outward to form an assembling portion, the second section is connected to the third section, at a juncture of the second and third sections is pivotally disposed a fixing member for fixing the steel cord, on an outer surface of the second section is formed an abutting portion, an abutting cavity formed in the abutting portion;
on the assembling portion of the first section is fixed a brake shoe;
a torsion spring is pivotally disposed at a juncture of the first and second sections and includes a fixing end, a deformable body, an extension portion and a restricting end, the fixing end is fixed in a fork tube, the deformable body is a helical structure, the extension portion extends over the abutting portion of the second section and is abutted against the abutting cavity of the abutting portion, and the restricting end is abutted against the brake arm.

2. The bicycle brake device as claimed in claim 1, wherein an elongated hole is formed in the assembling portion, and the brake shoe is fixed in the elongated hole of the assembling portion by a fastener.

3. The bicycle brake device as claimed in claim 1, wherein the restricting end of the torsion spring is L-shaped and inserted between the second and third sections of the brake arm to restrict a pivoting angle of the brake arm.

4. The bicycle brake device as claimed in claim 3, wherein the restricting end of the torsion spring is located adjacent to a corner between the second and third sections.

5. The bicycle brake device as claimed in claim 1, wherein the restricting end of the torsion spring is a semicircular structure to hook a far side of the fixing member with respect to the brake shoes.

6. The bicycle brake device as claimed in claim 1, wherein a threaded hole is formed in the abutting cavity, and an adjustment bolt is screwed in the threaded hole to push the extension portion of the torsion spring.

7. The bicycle brake device as claimed in claim 1, wherein an assembling hole is formed at a juncture of the second and first sections, the torsion spring is pivotally fixed to the brake arm by a positioning assembly which comprises a rod and a sleeve, the rod has one end formed with an inserting portion and another end formed with an engaging flange, the inserting portion is inserted in the assembling hole of the brake arm, the engaging flange is exposed out of the assembling hole, the sleeve is made of rubber and formed with a cylindrical body and a restricting flange, the deformable body of the torsion spring is sleeved on the cylindrical body of the sleeve, the cylindrical body is sleeved on the inserting portion of the rod and restricted from movement by the engaging flange, and consequently, the restricting flange of the sleeve is capable of restricting movement of the torsion spring.
